(19) United States
(12) Patent Application Publication
(10) Pub. No.: US 2019/0057470 A1
(43) Pub. Date: Feb. 21, 2019

(54) INTELLECTUAL PROPERTY SUPPORTING APPARATUS, INTELLECTUAL PROPERTY SUPPORTING METHOD, AND INTELLECTUAL PROPERTY SUPPORTING PROGRAM

(71) Applicant: GoldIP Inc., Tokyo (JP)

(72) Inventors: Hajime Shirasaka, Tokyo (JP); Rieko Harima, Tokyo (JP)

(21) Appl. No.: 15/803,941

(22) Filed: Nov. 6, 2017

(30) Foreign Application Priority Data
Aug. 17, 2017 (JP) 2017-157680

(51) Int. Cl. G06Q 50/18; G06F 17/30; G06N 99/00; G06N 5/02

(52) U.S. Cl. CPC G06Q 50/184; G06F 17/30528; G06F 2216/11; G06N 5/022; G06N 99/005

(57) ABSTRACT

An intellectual property supporting apparatus includes a recording unit configured to record intellectual property information and character information; an output unit configured to output a character to a user terminal operable by a user based on the character information recorded in the recording unit; a reception unit configured to receive information regarding intellectual property associated with the user as an inventor or an applicant transmitted from the user terminal; a calculation unit configured to calculate right acquisition possibility of the intellectual property based on the intellectual property information and the information regarding the intellectual property; and a controller configured to control output of a form of the character based on information on the right acquisition possibility calculated by the calculation unit.

### TECHNICAL FIELD

This disclosure relates to an intellectual property supporting apparatus that performs a procedure relating to intellectual property, an intellectual property supporting method, and an intellectual property supporting program.

### BACKGROUND

In recent years, apparatuses that evaluate inventions before application have been developed. Japanese Unexamined Patent Application Publication No. 2010-224984 discloses a patent specification evaluation/generation operation supporting apparatus that stores information regarding intellectual property and performs evaluation and support of generation of an application document before application. The patent specification evaluation/generation operation supporting apparatus disclosed in Japanese Unexamined Patent Application Publication No. 2010-224984 may store information on published unexamined patent applications including a notification of reasons for refusal and estimate description of the notification of reasons for refusal by performing similarity searching on the stored information for application documents before application.

Novelty and an inventive step of patents are controversial issues, for example. Although these issues are understandable by those who have knowledge of intellectual property, it may be difficult for those who do not have the knowledge of intellectual property to understand the issues.

Thus, there is a need for a system that causes even a user having less knowledge of the intellectual property law to easily understand information indicating whether registration of intellectual property has been performed.

### SUMMARY

We thus provide:
An intellectual property supporting apparatus includes a recording unit configured to record intellectual property information and character information, an output unit configured to output a character to a user terminal operable by a user based on the character information recorded in the recording unit, a reception unit configured to receive information regarding intellectual property associated with the user as an inventor or an applicant which is transmitted from the user terminal, a calculation unit configured to calculate right acquisition possibility of the intellectual property based on the intellectual property information and the information regarding the intellectual property, and a controller configured to control output of a form of the character based on information on the right acquisition possibility calculated by the calculation unit.
The calculation unit may generate in advance learning data used for machine learning to calculate the right acquisition possibility using the intellectual property information recorded in the recording unit and calculate the information on the right acquisition possibility from the learning data and the information regarding the intellectual property.
The calculation unit may calculate a new keyword to be added to the information regarding the intellectual property from the intellectual property information based on the learning data and the information on the right acquisition possibility, and the controller may output the new keyword through the character.
The intellectual property supporting apparatus may further include an extraction unit configured to extract information similar to the information regarding the intellectual property from the intellectual property information. The calculation unit may calculate the information on the right acquisition possibility based on the similar information.
The extraction unit may compare the information regarding the intellectual property with the similar information and extract new similar information in the similar information based on a result of the comparison.
The controller may select a form of the character based on the new similar information.
The controller may indicate the information on the right acquisition possibility through the character.
An intellectual property supporting method includes recording intellectual property information and character information, outputting a character to a user terminal operable by a user based on the recorded character information, receiving information regarding intellectual property transmitted from the user terminal, calculating right acquisition possibility of the intellectual property based on the intellectual property information and the information regarding the intellectual property, and controlling output of a form of the character based on calculated information on the right acquisition possibility.
An intellectual property supporting program causes a computer to execute a recording function of recording intellectual property information and character information, an outputting function of outputting a character to a user terminal operable by a user based on the recorded character information, a reception function of receiving information regarding intellectual property transmitted from the user terminal, a calculation function of calculating right acquisition possibility of the intellectual property based on the intellectual property information and the information regarding the intellectual property, and a control function of controlling output of a form of the character based on calculated information on the right acquisition possibility.

Thus, even a user having less knowledge of the intellectual property law may easily understand information indicating whether registration of intellectual property has been performed.

### BRIEF DESCRIPTION OF THE DRAWINGS

FIG. 1 is a diagram illustrating a configuration of an intellectual property system according to an example.

FIG. 2 is a flowchart of an operation of the intellectual property system according to the example.

FIG. 3 is a diagram schematically illustrating a liaison screen according to the example.

FIG. 4 is a diagram illustrating a process performed by an intellectual property supporting apparatus according to the example.

FIG. 5 is a diagram illustrating a form of an output to a user terminal according to the example.

FIG. 6 is a diagram illustrating another form of an output to a user terminal according to the example.

### DETAILED DESCRIPTION

An example will be described with reference to the accompanying drawing.

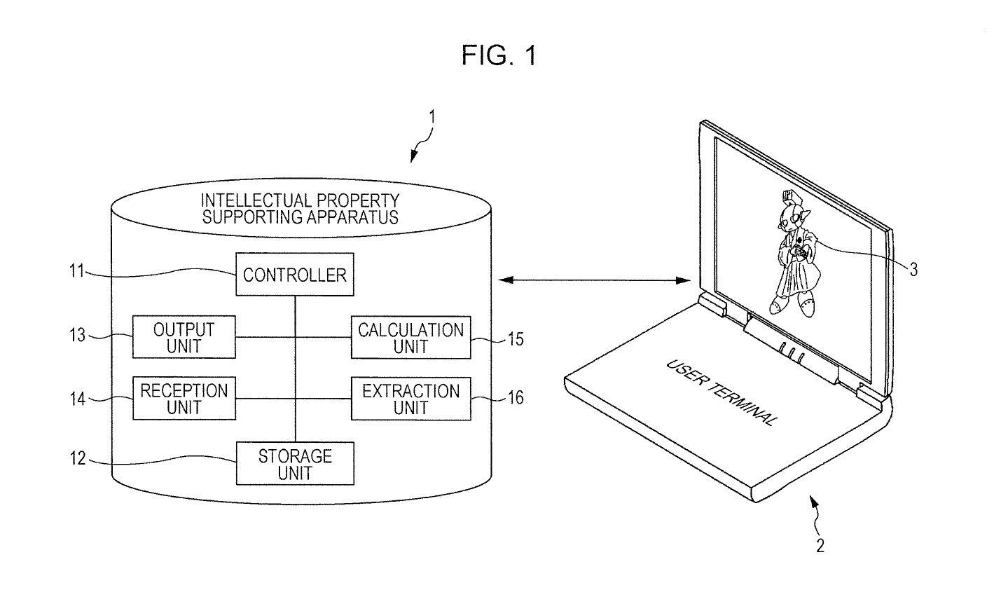

FIG. 1 is a diagram illustrating a configuration of an intellectual property system. As illustrated in FIG. 1, the intellectual property system includes an intellectual property supporting apparatus 1 and a user terminal 2 connected to each other through a network (NW).

The intellectual property supporting apparatus 1 includes a storage unit 12 that stores intellectual property information and character information, an output unit 13 that outputs a character 3 to the user terminal 2 operable by a user based on the character information stored in the storage unit 12, a reception unit 14 that receives information regarding intellectual property associated with the user as an inventor or an applicant and is transmitted from the user terminal 2, a calculation unit 15 that calculates right acquisition possibility of the intellectual property based on the intellectual property information and the information regarding the intellectual property, and a controller 11 that performs output control on a form of the character 3 based on information on the right acquisition possibility calculated by the calculation unit 15.

Since the right acquisition possibility of the intellectual property is calculated relative to the information regarding the intellectual property associated with the user as an inventor or an applicant and the output control is performed on the form of the character 3 based on the information on the calculated right acquisition possibility, the intellectual property supporting apparatus 1 may cause the user who has less knowledge of the intellectual property law to easily understand information indicating whether registration of the intellectual property has been performed.

The intellectual property supporting apparatus 1 includes the controller 11, the storage unit 12, the output unit 13, the reception unit 14, the calculation unit 15, and an extraction unit 16.

The intellectual property supporting apparatus 1 connects to the user terminal 2 through the NW to supply services of the intellectual property system to the user terminal 2. The intellectual property supporting apparatus 1 is a so-called server apparatus or a computer (including a desktop computer, a laptop computer, and a tablet), for example. The intellectual property supporting apparatus 1 is not limited to these examples.

The controller 11 is a processor having a function of controlling the units included in the intellectual property supporting apparatus 1. Examples of the controller 11 include a central processing unit, a microprocessor, a processor core, a multiprocessor, an application-specific integrated circuit (ASIC), and a field programmable gate array (FPGA). The controller 11 is not limited to these examples.

The controller 11 may perform output control on the form of the character 3 based on data regarding the intellectual property calculated by the calculation unit 15. Specifically, the controller 11 may perform output control on the form of the character 3 based on the information on the right acquisition possibility calculated by the calculation unit 15. Since the output control is performed on the form of the character 3 based on the data regarding the intellectual property calculated by the calculation unit 15, the intellectual property supporting apparatus 1 may realize expression of the information regarding the intellectual property by the character 3 and cause even a user who has less knowledge of the intellectual property law to easily understand the information regarding the intellectual property.

Specifically, the controller 11 may select the form of the character 3 based on similar information newly extracted by the extraction unit 16. Since the form of the character 3 is newly selectable based on the similar information newly obtained, the intellectual property supporting apparatus 1 may express the information regarding the intellectual property so that the user easily understand the information and, accordingly, even the user having less knowledge of the intellectual property law may easily understand the information regarding the intellectual property.

Specifically, the controller 11 may indicate the information on the right acquisition possibility calculated by the calculation unit 15 using the character 3. Since the information on the right acquisition possibility calculated by the calculation unit 15 is indicated using the character 3, the intellectual property supporting apparatus 1 may express the right acquisition possibility for the user so that the user easily understand the possibility. Accordingly, even a user having less knowledge of the intellectual property law may easily understand information indicating whether registration of the intellectual property has been performed.

The storage unit 12 stores various information in the intellectual property supporting apparatus 1. Furthermore, the storage unit 12 has a function of storing various programs and various data required for operation of the intellectual property supporting apparatus 1. The storage unit 12 is a recording medium such as a hard disc drive (HDD), a solid state drive (SSD), or a flash memory. The storage unit 12 may record information on the character 3 described below, machine learning and learning data, the intellectual property information, the information regarding the intellectual property associated as an inventor or an applicant, and the like.

The intellectual property information corresponds to the disclosed technical information or preferably corresponds to data regarding the intellectual property. Examples of the intellectual property information include disclosed information regarding intellectual property (on a web or in a newspaper), information on patents, information on design, information on trademarks, information on utility models, information on court cases, and information held by patent offices in various countries. Specifically, examples of the intellectual property information include a published unexamined patent application, bibliographic items described in the published unexamined patent application, a notification of reasons for refusal against application of the published unexamined patent application, content of the notification of reasons for refusal, information on cited documents in the notification of reasons for refusal, content of a response to the notification of reasons for refusal, the number of times correction is performed on the application of the published unexamined patent application, and content of the correction. The intellectual property information may not be the information regarding the intellectual property and may be information regarding a technique or disclosed information such as information on a web, a paper, or a magazine.

The character information corresponds to a person or an animal appearing in a fiction such as a novel, a cartoon, a movie, an animation, or a computer game on a computer or digital data representing a nature or a personality of such a character. For example, a character of samurai illustrated in FIG. 1 or a character of a judge or an examiner may be employed. The character information is recorded in the storage unit 12, for example. As the character information, a single output form or a plurality of output forms for each character are recorded in the storage unit 12. Specifically, the storage unit 12 records poses of delight, anger, sorrow, and pleasure representing whether the intellectual property right of a samurai character represented by the information on the character 3 has been acquired.

The output unit 13 outputs various information in the intellectual property supporting apparatus 1 to the user terminal 2. Specifically, the output unit 13 may output the character 3 to the user terminal 2 operable by the user and express whether the intellectual property right has been acquired by the character 3. Specifically, the output unit 13 may also output information on right acquisition possibility of the information regarding the intellectual property transmitted from the user terminal 2 to the user terminal 2, for example. Examples of the information on right acquisition possibility of the information regarding the intellectual property includes a simulated notification of reasons for refusal (a simulated notification similar to a notification of reasons for refusal) and a comparison table between information regarding the intellectual property associated as an inventor or an applicant and similar information extracted by the extraction unit 16 described below. In a patent, examples of the information regarding intellectual property associated as an inventor or an applicant include an invention memorandum including invention information and information on claims. The similar information is a prior art document, for example, and the comparison table is a so-called claim chart which represents technical differences.

The reception unit 14 receives various information transmitted from the user terminal 2. Specifically, the reception unit 14 may receive the information regarding the intellectual property transmitted from the user terminal 2.

The information regarding the intellectual property is data of the user associated with the intellectual property which is transmitted from the user terminal 2. Examples of the information regarding the intellectual property include information regarding the intellectual property associated with the user as an inventor, a creator, or an applicant, that is, a draft of an application for trademark registration, an application for design registration, an application for a patent, or an application for utility model registration. Specifically, examples of the information on the intellectual property include an invention memorandum including technical information regarding the invention of the user, and documents of an application for trademark registration, an application for design registration, an application for a patent, and an application for utility model registration which have been generated or which are being generated.

Examples of the data of the user associated with the intellectual property include a document of a specification form, character information of a predetermined format such as a document having a form of claims, character information which does not have a predetermined format such as an invention memorandum including technical points or schematic diagrams, audio information, and image information, which are data transmittable through the NW.

Furthermore, the reception unit 14 may receive the information regarding the intellectual property such that the reception unit 14 outputs a format to record the information regarding the intellectual property stored in the storage unit 12 to the user terminal 2 through the output unit 13 and the user records the information regarding the intellectual property of the user in the format. For example, the format output from the output unit 13 may be an upload screen having a function of enabling upload of data, and the user may upload data of the intellectual property of the user. For example, the format output from the output unit 13 may include information required for a patent application as description items including means for solving the problem and effects of the invention.

Since the format is used, the intellectual property supporting apparatus 1 may specify information to be transmitted and a method of transmitting the information in the information regarding the intellectual property of the user when the information is transmitted from the intellectual property supporting apparatus 1 from the user so that the user more easily transmits the information regarding the intellectual property to the intellectual property supporting apparatus 1. Furthermore, since the format is used, the intellectual property supporting apparatus 1 may specify information to be transmitted and a method of transmitting the information in the information regarding the intellectual property of the user when the information is transmitted from the intellectual property supporting apparatus 1 from the user, and accordingly, required information may be easily collected when data regarding the intellectual property is calculated (when the right acquisition possibility is calculated, for example), and the data regarding the intellectual property (the right acquisition possibility, for example) may be more accurately calculated with ease.

Furthermore, the reception unit 14 may receive various information from the user terminal 2 using a chat room 1003 in a liaison screen 1000 described below. Since the chat room 1003 is used, the intellectual property supporting apparatus 1 may perform hearings with the user, may facilitate collection of information required when the data regarding the intellectual property is calculated (when the right acquisition possibility is calculated, for example) in the information regarding the intellectual property of the user, and may more accurately calculate the data regarding the intellectual property (the right acquisition possibility, for example) with ease.

The calculation unit 15 calculates the data regarding the intellectual property based on the information stored in the storage unit 12 and the data received by the reception unit 14 from the user terminal 2. For example, the calculation unit 15 may calculate the right acquisition possibility of the intellectual property based on the intellectual property information stored in the storage unit 12 and the information regarding the intellectual property received by the reception unit 14 from the user terminal 2. Furthermore, as the calculation of the right acquisition possibility of the intellectual property, components in a description “information regarding the intellectual property associated as an inventor, a creator, or an applicant,” are divided according to a punctuation, for example. Alternatively, the components may be divided according to a length of a certain sentence or a predicate. After identifying the components, the calculation unit 15 obtains similar information by the extraction unit 16 described below and calculates a degree of similarity between the components and the similar information. When the similar information is the same as a keyword of one of the components, or when a keyword of the similar information is a narrower concept relative to the keyword of the component, it may be determined that a matching degree is high. The calculation unit 15 may calculate presence or absence of a narrower concept or a broader concept with reference to a corpus dictionary of words which is recorded in advance in the storage unit 12.

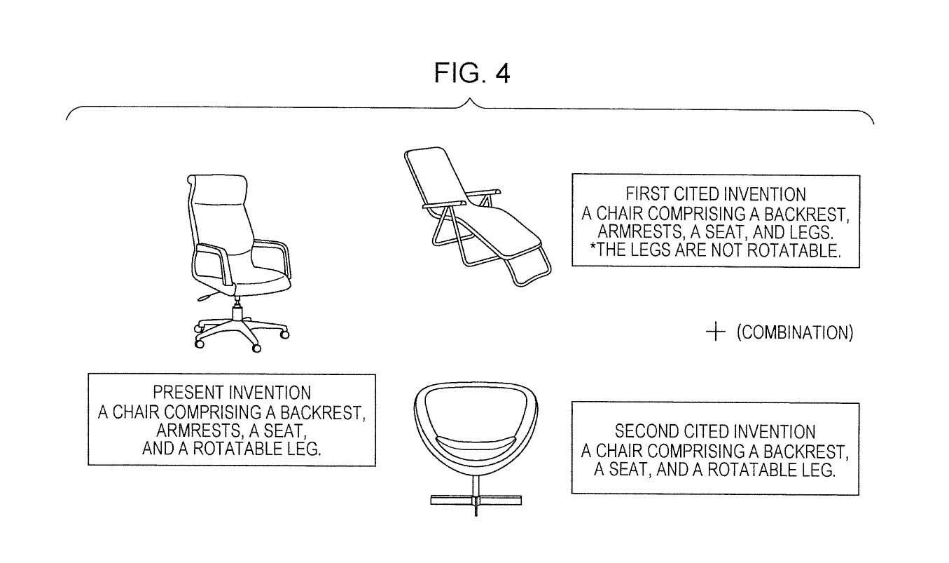

The calculation unit 15 performs a score calculation to obtain a degree of matching between the components and the similar information. A determination as to whether the components and the similar information match each other is performed by a threshold value process so that matching points and different points of the components are calculated. A threshold value may be determined in advance or a score calculated by machine learning may be used. When a difference is recognized, the calculation unit 15 newly obtains a similar patent relative to one of the components having a high difference point (a low matching point) through the extraction unit 16 described below. For example, it is assumed that information regarding the intellectual property associated as an inventor, a creator, or an applicant indicates “a chair comprising a backrest, armrests, a seat, and a rotatable leg” (hereinafter referred to as the present invention) as illustrated in FIG. 4. It is further assumed that the extraction unit 16 extracts a publication of “a chair comprising a backrest, armrests, a seat, and legs” (a cited reference 1) as similar information. In this case, when the present invention is compared to the cited reference 1 on a component-by-component basis, a score of 100 points is obtained in the matched portions “a backrest” and “armrests.” However, although “a rotatable leg” is described in the present invention, only “legs” is described in the cited reference 1 and, therefore, a high score is not obtained according to the number of matched characters. For example, 30 points is obtained which is a low matching score. In this case, when determining that a matching score is low, the calculation unit 15 instructs the extraction unit 16 to newly extract similar information, and the extraction unit 16 newly obtains similar information to cover the component having the low matching score. Then the extraction unit 16 newly extracts a publication of “a chair comprising a backrest, a seat, and a rotatable leg” (a cited reference 2) as similar information. A score of 100 points is obtained since the descriptions “a rotatable leg” match each other. If a description “a chair comprising a backrest, a seat, and a rotatable fixed stand” is included in the cited reference 2 and if the term “fixed stand” is a narrower concept of the term “leg” according to the corpus dictionary described above, 100 points or a high score is obtained.

The right acquisition possibility indicates a degree of possibility of acquisition of rights of intellectual property corresponding to the information regarding the intellectual property received by the reception unit 14 from the user terminal 2 or an evaluation for acquisition of rights of intellectual property. The degree of the possibility of the acquisition of the right of the intellectual property may be represented in a form of percentage (80%, for example) of the right acquisition possibility, for example. The evaluation for acquisition of the rights of the intellectual property may be represented by a result of a determination as to whether a patent is to be granted, a patent is to be rejected, or a reason for refusal is notified, or represented by a reason for refusal if any when the intellectual property corresponds to an invention, for example.

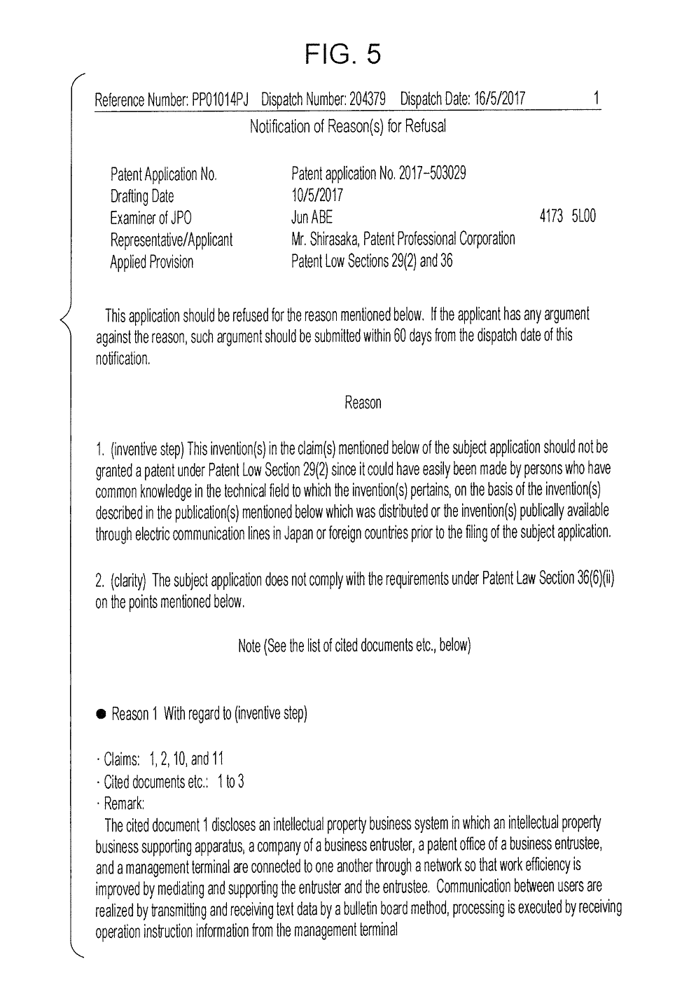

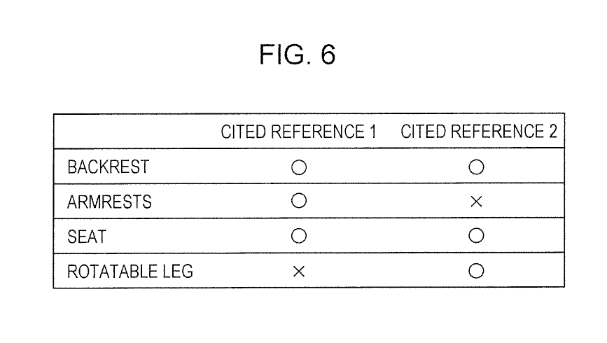

Furthermore, the right acquisition possibility may be represented by a simulated notification of reasons for refusal or a table of comparison between the information regarding the intellectual property associated as an inventor or an applicant and the similar information extracted by the extraction unit 16 described below. In a patent, the information regarding the intellectual property associated as an inventor or an applicant corresponds to an invention memorandum or claims, the similar information corresponds to a cited reference, and the comparison table corresponds to a so-called “claim chart,” for example. FIG. 5 is a diagram illustrating the simulated notification of reasons for refusal. FIG. 6 is a diagram illustrating the claim chart representing the relationship among the present invention, the cited reference 1, and the cited reference 2 described above. The calculation unit 15 may perform calculation such that a component having a low matching score is denoted by “X” and a component having a high matching score is denoted by “O.”

Furthermore, the calculation unit 15 may generate learning data to be used for the machine learning to calculate the right acquisition possibility in advance using the intellectual property information stored in the storage unit 12 and calculate information on the right acquisition possibility using the learning data and the information regarding the intellectual property. Since the learning data is generated using the intellectual property information stored in the storage unit 12 and the information on the right acquisition possibility is calculated using the learning data and the information regarding the intellectual property, the intellectual property supporting apparatus 1 may more accurately calculate the information on the right acquisition possibility with ease based on the intellectual property information (past patent information, for example).

Furthermore, the calculation unit 15 may calculate the information on the right acquisition possibility of the information regarding the intellectual property received from the user terminal 2 using a machine-learned model obtained using the intellectual property information stored in the storage unit 12 so that the right acquisition possibility is obtained. Accordingly, the intellectual property supporting apparatus 1 may calculate the information on the right acquisition possibility based on the intellectual property information (past patent information, for example) more speedily, more accurately, and more easily.

The intellectual property information used in the machine learning is digitalized in advance before being processed for each item of the intellectual property information, and the information regarding the intellectual property supplied from the user terminal 2 is also digitalized before the information on the right acquisition possibility is calculated.

The item associated with the intellectual property information digitalized in advance may be various information associated with a published unexamined application relating to intellectual property, for example. Examples of the various information associated with a published unexamined application relating to intellectual property include a publication date of the published unexamined application, a hand-in date (or an application date) of an application document of the published unexamined application, the number of times a notification of reasons for refusal to the application of the published unexamined application is received, content of the notification of reasons for refusal, content of a response to the notification of reasons for refusal, the number of times correction is performed on the application of the published unexamined application, content of the correction, the number of characters in an independent claim, and the number of claims.

The calculation unit 15 may receive an actual result of the information regarding the intellectual property corresponding to the right acquisition possibility calculated using the intellectual property supporting apparatus 1 in the past from the reception unit 14 as a feedback to calculate the right acquisition possibility, and may use the received result in the machine learning. By this, the intellectual property supporting apparatus 1 may calculate the information on the right acquisition possibility with higher accuracy.

When the right acquisition possibility is negative as a result of the calculation on the information regarding the intellectual property supplied from the user terminal 2, the calculation unit 15 may extract a keyword from the intellectual property information stored in the storage unit 12 and calculate the right acquisition possibility when the extracted keyword is used instead of or in addition to a keyword used in the information regarding the intellectual property supplied from the user terminal 2. The calculation unit 15 may repeatedly extract a keyword until the right acquisition possibility becomes positive. When the right acquisition possibility becomes positive, the output unit 13 may output the extracted keyword to the user terminal 2. The keyword may be randomly extracted from the intellectual property information stored in the storage unit 12, sequentially extracted from the information regarding the intellectual property supplied from the user terminal 2, or extracted based on a method for extracting a keyword determined in advance using the Osborn's checklist. Accordingly, the intellectual property supporting apparatus 1 may perform, in addition to calculation of the information on the right acquisition possibility relative to the information regarding the intellectual property supplied from the user terminal 2, display of information indicating a method of acquiring rights of the information regarding the intellectual property and, accordingly, even a user who has less knowledge of the intellectual property law may easily understand and obtain the information regarding the intellectual property.

Examples of the keyword include a sentence, a character, an idiom, a word, a symbol, an alphabet, a chemical formula, and a number.

Furthermore, when the right acquisition possibility is negative as a result of calculation on the information regarding the intellectual property supplied from the user terminal 2, the calculation unit 15 may extract a keyword from the intellectual property information stored in the storage unit 12. In this case, the calculation unit 15 may extract a keyword that realizes the right acquisition possibility obtained when the extracted keyword is used instead of or in addition to the keyword used in the information regarding the intellectual property received from the user terminal 2 and positioned at an end in distribution of the positive right acquisition possibility. Since the keyword that realizes the right acquisition possibility obtained when the extracted keyword is used instead of or in addition to the keyword used in the information regarding the intellectual property received from the user terminal 2 and is positioned at an end in distribution of the positive right acquisition possibility is extracted, the intellectual property supporting apparatus 1 may display a keyword enabling an increase in the scope of an obtainable right when restricting the information regarding the intellectual property using the extracted keyword. When the information regarding the intellectual property indicates an invention to be applied as a patent, for example, the intellectual property supporting apparatus 1 may extract a keyword that limits the invention in a wider range while the right acquisition possibility of the invention is positive.

Specifically, the calculation unit 15 may newly calculate a keyword to be added to the information regarding the intellectual property based on the learning data and the information on the right acquisition possibility from the intellectual property information, and the controller 11 may output the new keyword through the character 3. Accordingly, the intellectual property supporting apparatus 1 may express the information regarding the intellectual property so that the user easily understands the information. Consequently, even a user who has less knowledge of the intellectual property law may easily propose an invention including the new keyword as the information regarding the intellectual property.

The extraction unit 16 extracts information similar to the information received by the reception unit 14 from the user terminal 2 from the information stored in the storage unit 12 or information in various databases obtained through the NW. Specifically, the extraction unit 16 may extract information similar to the information regarding the intellectual property received by the reception unit 14 from the user terminal 2 from the intellectual property information stored in the storage unit 12 or various services that provide patent documents and papers and connect through the NW. More specifically, the extraction unit 16 may extract, from published unexamined patent applications stored in the storage unit 12 or obtained through the NW, a published unexamined patent application, or a patent publication, an international bulletin similar to the information regarding the invention received by the reception unit 14 from the user terminal 2. Although a patent is described as the publication, for example, in other laws, publications of an application for trademark registration, an application for design registration, a patent application, and an application of utility model registration also correspond to the similar information. The publication recorded in databases in patent offices in various countries may be copied in the storage unit 12 in advance.

The similar information corresponds to data similar to the information regarding the intellectual property described above in the intellectual property information stored in the storage unit 12. Specifically, when the information regarding intellectual property corresponds to a document associated with a technique, a patent publication, a publication of a utility model, or the like similar to content of the document may be extracted, and when the information on intellectual property corresponds to design, the similar information may correspond to a similar design publication or a similar publication of an application for trademark registration.

Furthermore, the calculation unit 15 may calculate the data regarding the intellectual property based on the similar information extracted by the extraction unit 16. Specifically, the calculation unit 15 may calculate the right acquisition possibility based on the similar information extracted by the extraction unit 16. More specifically, the calculation unit 15 may calculate the right acquisition possibility of the invention received from the user terminal 2 by using a published unexamined patent application similar to information associated with the invention received from the user terminal 2 and extracted by the extraction unit 16 as data. Since the calculation unit 15 calculates the data regarding the intellectual property based on the similar information extracted by the extraction unit 16, the intellectual property supporting apparatus 1 may use more detailed data and a larger amount of data and accuracy of calculation of the data regarding the intellectual property may be improved.

The extraction unit 16 may specify at least one keyword in the information regarding the intellectual property received by the reception unit 14 and extract information similar to the information received by the reception unit 14 from the user terminal 2 from the information stored in the storage unit 12 or information included in the various databases obtained through the NW based on the keyword. In this case, the extraction unit 16 may extract information similar to the information received from the user terminal 2 from the information stored in the storage unit 12 or the information included in the various databases obtained through the NW based on, instead of the specified keyword, a new keyword which is a synonym of the specified keyword or a narrower concept of the specified keyword. The new keyword which is a synonym of the keyword or a narrower concept of the keyword may be selected by being obtained from the storage unit 12 including stored databases and a stored dictionary such as corpus, or from information included in the various databases obtained through the NW.

The information regarding the intellectual property received by the reception unit 14 and the similar information may be more easily used by extracting the similar information based on the keyword, and the relationship between the information regarding the intellectual property received by the reception unit 14 and the similar information may be clearly defined. Since the similar information is extracted based on the keyword, the keyword in the information regarding the intellectual property received by the reception unit 14 may be used. Therefore, the similar information may be extracted using a new keyword which is a synonym of the keyword or a narrower concept of the keyword, for example, and accordingly, more multifaceted extraction of similar information may be performed. The extraction of the similar information using the new keyword which is a synonym or a narrower concept of the keyword is a viewpoint used in an examination of novelty and an inventive step of a patent, for example, and the extraction of similar information by such a method is similar to a method of the examination in the patent office. Accordingly, calculation of data regarding the intellectual property (calculation of information on the right acquisition possibility, for example) may be performed with higher reliability. Furthermore, since the similar information is extracted based on a keyword, a keyword in the information regarding the intellectual property received by the reception unit 14 may be used. Accordingly, a similarity degree with the similar information may be calculated based on the relationship between the at least one keyword and the similar information including the keyword, for example, and accordingly, data regarding the intellectual property may be more specifically and more clearly calculated (calculation of the information on the right acquisition possibility, for example).

The extraction unit 16 may specify at least one keyword in the information regarding the intellectual property received by the reception unit 14 and further specify at least one keyword which is a synonym or a narrower concept of the keyword in the received information regarding the intellectual property to extract information similar to the information received from the user terminal 2 based on the further specified keyword. Specifically, if the information regarding the intellectual property received by the reception unit 14 is character information of a predetermined format such as a document having a form of a specification or a document having a form of claims, all keywords in descriptions of important points of the invention in “Means for Solving the Problem(s)” and independent claims may be specified, keywords which are synonyms or narrower concepts of the plurality of keywords may be further specified in descriptions explaining the specified keywords such as a description of a specification or a description of dependent claims, and information similar to the information received from the user terminal 2 may be extracted using the plurality of further specified keywords. Accordingly, the keyword of the information regarding the intellectual property received by the reception unit 14 may be specified using the information regarding the intellectual property and, accordingly, information supplied from the user may be more reliably obtained.

The extraction unit 16 may compare the information regarding the intellectual property received by the reception unit 14 with the similar information extracted by the extraction unit 16 and extract new similar information of the similar information based on a result of the comparison. By this, more multifaceted extraction of similar information may be performed.

The extraction unit 16 may specify at least one keyword in the information regarding the intellectual property received by the reception unit 14 as illustrated in FIG. 4, extract information similar to the information received from the user terminal 2 based on the keyword from the information stored in the storage unit 12 or the information included in the various databases obtained through the NW, performs a comparison to determine whether the specified keyword is included in the similar information, and extract new similar information from the information stored in the storage unit 12 or the information included in the various databases obtained through the NW again based on at least one keyword not included in the similar information and included in the specified keyword. The information similar to the information received from the user terminal 2 may be extracted from the information stored in the storage unit 12 or the information included in the various databases obtained through the NW based on, instead of the specified keyword, a keyword which is a synonym or a narrower concept of the keyword. The new keyword which is a synonym of the keyword or a narrower concept of the keyword may be selected by being obtained from the storage unit 12 including stored databases and a stored dictionary such as corpus, or from information included in the various databases obtained through the NW.

By this, more multifaceted extraction of similar information may be performed. Furthermore, the extraction of similar information by such a method is a viewpoint used in an examination of an inventive step of a patent, for example, and is similar to a method of the examination in the patent office. Accordingly, calculation of data regarding the intellectual property (calculation of information on the right acquisition possibility, for example) may be performed with higher reliability.

The extraction unit 16 performs a process of dividing the invention memorandum of the patent according to configurations as essences and searches for similar patents for the individual configurations. Specifically, similar information such as a publication or a web described as one document, is extracted, that is, information similar to the individual configurations is extracted. Alternatively, approximate similar information may be extracted for the entire invention memorandum instead of the individual configurations.

Furthermore, the calculation unit 15 may calculate information on the right acquisition possibility using at least one of results of patterns described below. Furthermore, the calculation unit 15 may determine whether the invention is to be rejected or not to be rejected based on a calculated result in accordance with the patterns below or the score and the threshold value process described above. Specifically, a similar patent of a portion of the invention in which a right of an idea thereof is to be acquired is extracted as described above. The invention is divided into a plurality of components to be recognized and levels of matching points between similar patents and the individual components are scored. For example, score calculation may be performed on a character or a character string by a distance calculation method such as the Levenshtein distance. Furthermore, a second similar patent of a component having a low score (a different point) is extracted by the extraction unit 16. Feature values of the present invention, the cited references 1 and 2, and a publication in the same or a similar technical field may be calculated using machine learning such as a neural network or a boosting process, and information on the right acquisition possibility may be calculated by a distance calculation after projection calculation by the machine learning so that scoring is performed. For example, information on a fact that the present invention and international patent classification of the cited references 1 and 2 are the same or similar, a length of claims, and the number of times the document is referenced may be used as the feature values. The calculation unit 15 may calculate the information on the right acquisition possibility by a threshold value calculation by the score calculation method performed for each component or for all the components which is not the machine learning. The calculation unit 15 generates the simulated notification of reasons for refusal or the claim chart described above.

As a second pattern, the calculation unit 15 extracts an invention similar to the present invention in which the right of an idea is to be acquired, extracts a notification of reasons for refusal issued in the past relative to the similar patent, and determines whether the patent right has been finally granted. The calculation unit 15 may generate a simulated notification of reasons for refusal or a claim chart in accordance with information on a result of the determination. The calculation unit 15 may use the result of the past notification of reasons for refusal as it is or may generate a simulated notification of reasons for refusal or a claim chart using a result of combination of the result and a result of the first pattern described above.

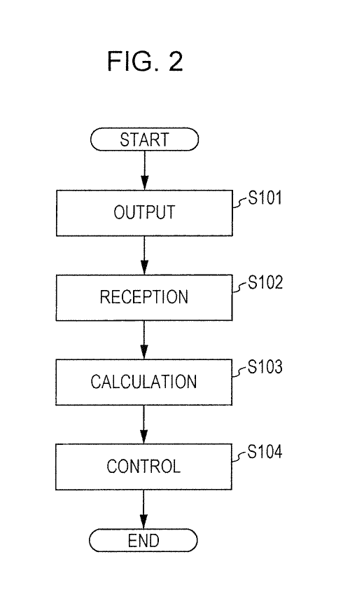

FIG. 2 is a flowchart of an operation of the intellectual property supporting apparatus 1 according to the example.

As illustrated in FIG. 2, when connected to the user terminal 2 through the NW, the intellectual property supporting apparatus 1 outputs various information stored in the storage unit 12 to the user terminal 2 from the output unit 13 (S101). Specifically, the intellectual property supporting apparatus 1 may output the character 3 stored in the storage unit 12 to the user terminal 2 from the output unit 13.

The various information transmitted from the user terminal 2 is received by the reception unit 14 (S102). Subsequently, the calculation unit 15 calculates data regarding the intellectual property based on the information received by the reception unit 14 and the information stored in the storage unit 12 (S103). Specifically, the calculation unit 15 may calculate the right acquisition possibility of the intellectual property based on the information regarding the intellectual property received by the reception unit 14 and the intellectual property information stored in the storage unit 12.

Specifically, the calculation unit 15 may generate learning data to be used for the machine learning to calculate the right acquisition possibility using the intellectual property information stored in the storage unit 12 in advance and calculate the information on the right acquisition possibility using the leaning data and the information regarding the intellectual property.

Specifically, the calculation unit 15 may calculate a new keyword to be added to the information regarding the intellectual property using the intellectual property information based on the leaning data and the information on the right acquisition possibility.

At the time of the calculation performed by the calculation unit 15 or before or after the calculation performed by the calculation unit 15, the extraction unit 16 may extract information similar to the information received by the reception unit 14 from the user terminal 2 from the information stored in the storage unit 12. Specifically, the extraction unit 16 may extract information similar to the information regarding the intellectual property received by the reception unit 14 from the user terminal 2 from the intellectual property information stored in the storage unit 12 at the time of the calculation performed by the calculation unit 15 or before or after the calculation performed by the calculation unit 15. More specifically, the extraction unit 16 may extract a published unexamined patent application similar to the information associated with the invention received by the reception unit 14 from the user terminal 2 among published unexamined patent applications stored in the storage unit 12.

Furthermore, the calculation unit 15 may calculate data on the intellectual property based on the similar information extracted by the extraction unit 16. Specifically, the calculation unit 15 may calculate the right acquisition possibility based on the similar information extracted by the extraction unit 16. More specifically, the calculation unit 15 may calculate the right acquisition possibility of the invention received from the user terminal 2 based on a published unexamined patent application which is similar to the information associated with the invention received from the user terminal 2 and which is extracted by the extraction unit 16.

The extraction unit 16 may compare the information regarding the intellectual property received by the reception unit 14 to the similar information extracted by the extraction unit 16 and extract new similar information among the similar information based on a result of the comparison.

Furthermore, the extraction unit 16 may compare the information regarding the intellectual property received by the reception unit 14 to the similar information extracted by the extraction unit 16 and extract new similar information among the similar information based on a result of the comparison.

The controller 11 controls information to be output to the user terminal 2 based on the data regarding the intellectual property calculated by the calculation unit 15 or the similar information extracted by the extraction unit 16 (S104). Specifically, the controller 11 may perform output control on the form of the character 3 based on the information on the right acquisition possibility calculated by the calculation unit 15. For example, when the calculation unit 15 determines that the information on the right acquisition possibility indicates rejection, the controller 11 selects a character expressing sorrow in character information recorded in the storage unit 12 and issues an output instruction for displaying the character 3 to the output unit 13. Alternatively, when the calculation unit 15 determines that the information on the right acquisition possibility described above indicates rejection, the controller 11 may select a character expressing sorrow in the character information recorded in the storage unit 12 based on the score and the projection distance information and issues an output instruction for displaying the character to the output unit 13.

Furthermore, the controller 11 may output a keyword calculated by the calculation unit 15 through the character 3. The calculation unit 15 extracts a keyword from the intellectual property information recorded in the storage unit 12. Specifically, when determining that the information on the right acquisition possibility indicates rejection, the calculation unit 15 calculates a new keyword in accordance with a logic to determine a new keyword to be added that does not correspond to the information on the right acquisition possibility indicating the rejection. Although the calculation unit 15 may list a large number of new keywords, the situation becomes complicated and, therefore, at the time of the calculation, keywords described in claims in a publication in the same or a similar technique may be calculated or only new keywords corresponding to limitation of a distance movement in which a distance in the projection in the machine learning is not rejected may be extracted.

Furthermore, the controller 11 may select the form of the character 3 based on new similar information extracted by the extraction unit 16. Specifically, a form of expression of a character such as delight, anger, sorrow, or pleasure, to be output is selected in accordance with the new similar information and a degree of a score of a component.

Furthermore, the controller 11 may display the information on the right acquisition possibility calculated by the calculation unit 15 through the character 3. Furthermore, although the controller 11 outputs the selected form through the output unit 13, the controller 11 may output the right acquisition possibility, the claim chart, and the simulated notification of reasons for refusal.

The controller 11 may output a form of a document of a result of an actual examination to the user terminal 2 based on the data regarding the intellectual property calculated by the calculation unit 15 or the similar information extracted by the extraction unit 16. Examples of the document of a result of an actual examination include a notification of reasons for refusal, a notice of allowance, and a notification of decision of rejection. By this, the user may recognize the data regarding the intellectual property calculated by the calculation unit 15 or the similar information extracted by the extraction unit 16 in a form similar to the actual examination.

Specifically, the controller 11 may store a notification of reasons for refusal, a notice of allowance, or a notification of decision of rejection in the storage unit 12 to correspond to the right acquisition possibility calculated by the calculation unit 15, and output the stored notification of reasons for refusal, the stored notice of allowance, or the stored notification of decision of rejection to the user terminal 2 when the calculation unit 15 calculates the right acquisition possibility of the intellectual property based on the information regarding the intellectual property received by the reception unit 14 or the intellectual property information stored in the storage unit 12. A detailed description of the notification of reasons for refusal, the notice of allowance, or the notification of decision of rejection (a description of reasons in the notification of reasons for refusal, for example) may be blank. When the information regarding the intellectual property received from the user terminal 2 indicates an invention and the information on the right acquisition possibility calculated by the calculation unit 15 breaches Article 29(2), the controller 11 may output the notification of reasons for refusal indicating violation of Article 29(2) stored in advance for the case to the user terminal 2. By this, the user may recognize the data regarding the intellectual property calculated by the calculation unit 15 in a form similar to the actual examination.

Furthermore, the controller 11 may store the notification of reasons for refusal in the storage unit 12 so that the notification of reasons for refusal corresponds to the right acquisition possibility calculated by the calculation unit 15 as illustrated in FIG. 5. When the calculation unit 15 calculates the right acquisition possibility of the intellectual property, the controller 11 may output content of the description of the notification of reasons for refusal which is changed based on the similar information and/or the keyword extracted by the extraction unit 16 to the user terminal 2 while selecting the stored notification of reasons for refusal in the storage unit 12. When the information regarding the intellectual property received from the user terminal 2 indicates an invention, for example, the information on the right acquisition possibility calculated by the calculation unit 15 indicates violation of Article 29(2), the similar information indicates Japanese Unexamined Patent Application Publication No. 1234-567890, a specified keyword included in the similar information is “AAA,” a specified keyword which is not included in the similar information is “BBB,” and similar information newly extracted based on the keyword “BBB” indicates Japanese Unexamined Patent Application Publication No. 9876-543210, the controller 11 may select a notification of reasons for refusal indicating violation of Article 29(2), that uses two cited documents, and has one configuration specified as a difference from a cited document 1 and may output the notification including a word of a configuration used in the description of the cited documents and the notification of reasons for refusal to the user terminal 2 and changed to the similar information and the keyword. By this, the user may recognize the data regarding the intellectual property calculated by the calculation unit 15 or the similar information extracted by the extraction unit 16 in a form similar to the actual examination and may have an opportunity of devising a better invention.

The controller 11 may output the notification of reasons for refusal to the user terminal 2 as it is when the similar information extracted by the extraction unit 16 matches a portion of or an entire cited document associated with the notification of reasons for refusal stored in the storage unit 12. By this, the output to the user terminal 2 may be easily performed at high speed.

The controller 11 may output a form of the score table to the user terminal 2 based on the data regarding the intellectual property calculated by the calculation unit 15 or the similar information extracted by the extraction unit 16. Accordingly, expression using the score table that is easy to understand is enabled, and even a user having less knowledge of the intellectual property law may easily understand information regarding the intellectual property.

The controller 11 may output, in a form of the score table, an item associated with the intellectual property to be used when the property acquisition possibility is calculated and digitalized in advance relative to the information on the right acquisition possibility calculated by the calculation unit 15, for example. Accordingly, expression of items that are a base of the calculation of the right acquisition possibility is realized by the score table which is a method easy to understand, and even a user having less knowledge of the intellectual property law may easily understand information regarding the intellectual property.

The controller 11 may output the similar information extracted relative to at least one keyword specified by the information regarding the intellectual property received by the reception unit 14 to the user terminal 2 in a form of the score table as illustrated in FIG. 6. Specifically, the controller 11 may output the number of extracted similar information or a rate of the extracted similar information to the user terminal 2 in a form of the score table for at least one keyword specified by the information regarding the intellectual property received by the reception unit 14. Accordingly, expression of the similar information relative to the information regarding the intellectual property is enabled by the score table which is an easily-understandable method, and even a user having less knowledge of the intellectual property law may easily understand information regarding the intellectual property.

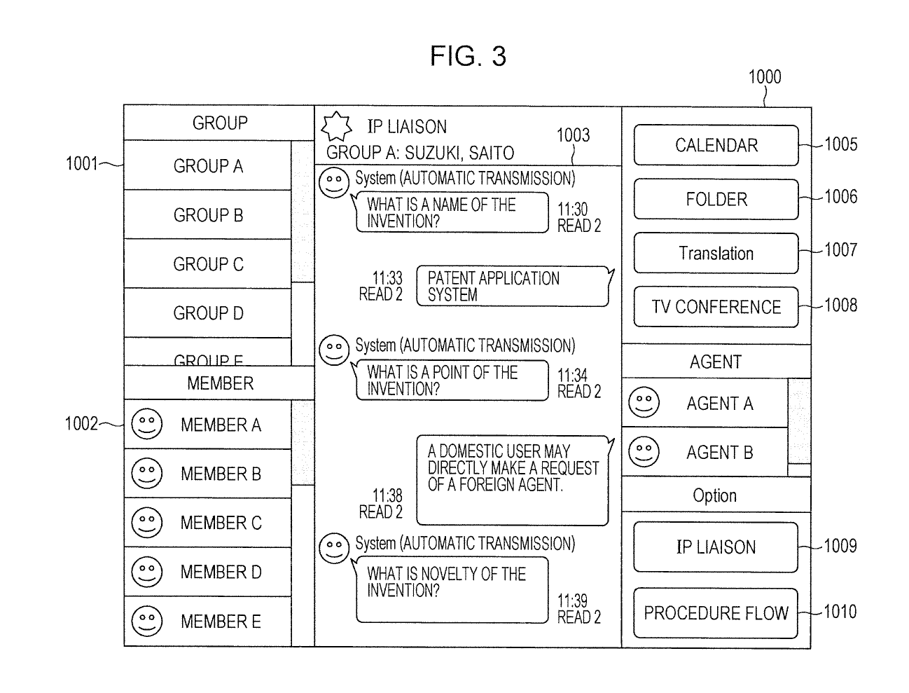

FIG. 3 is a diagram schematically illustrating a configuration of the liaison screen 1000 which provides an IP liaison function of the intellectual property supporting apparatus 1.

The IP liaison is a service that may obtain information regarding the intellectual property from the user by asking a certain question to the user. Specifically, the IP liaison may obtain the invention from the user by asking a certain question to the user. In the IP liaison, a certain question such as a question “What is a point of the invention?” or a question “where is a new portion of the invention?” is issued and a response to the question is obtained from the user so that the information regarding the intellectual property is clarified. The questions issued to the user in the IP liaison are not limited to the examples, and any question may be issued as long as the information on the intellectual property is obtained. For example, the IP liaison may clarify the invention of the user to establish the right by asking various questions to the user.

As illustrated in FIG. 3, the liaison screen 1000 includes various icons and the chat room 1003. The various icons include a group icon 1001, a member icon 1002, the chat room 1003, an agent icon 1004, a calendar icon 1005, a folder icon 1006, a translation icon 1007, a TV conference icon 1008, an IP liaison icon 1009, and a procedure flow icon 1010.

The liaison screen 1000 includes the chat room 1003 used to ask various questions of the information regarding the intellectual property and display responses from the user as illustrated in FIG. 3. As illustrated in FIG. 3, the questions to the user may be automatically performed by the system or a manager or a staff of the intellectual property supporting apparatus 1. The user responses the individual questions displayed in the chat room 1003. The responses from the user may be automatically stored in the storage unit 12. Specifically, the responses from the user may be automatically stored in the folder 1006 of the storage unit 12. The user may use the information stored in the folder 1006. For example, the user may check the invention using the information stored in the folder 1006 or perform a certain procedure associated with a patent application.

A plurality of users may participate in the chat room 1003 of FIG. 3 and respond to questions as a team so that the information regarding the intellectual property is clarified. Furthermore, the responses from the user in the chat room 1003 in FIG. 3 may be stored in the folder 1006 along with date and times, and a file stored in the folder 1006 may be used as a so-called note.

Furthermore, a function of the IP liaison may be configured such that a prior document search is executed based on content of the responses of the user. The intellectual property supporting apparatus 1 connects to various services that provide patent documents and papers through the network and execute the prior document search based on content of responses of the inventor. The intellectual property supporting apparatus 1 may automatically upload the detected prior documents in the chat room 1003.

Furthermore, the function of the IP liaison may display the relationship between the invention of the user and the detected prior document as a tree-shaped map in the chat room 1003 or another page. The user may recognize the relationship between the invention of the user and the associated documents with reference to the tree-shaped map, and patentability of the invention of the user may be discussed or the invention of the user may be further blushed up using the associated documents and the like. The IP liaison function may display the relationship between prior documents instead of the relationship with the invention of the user. Furthermore, the IP liaison function may display the relationship by a method other than the tree-shaped map.

Furthermore, the IP liaison function may display the similarity between the invention of the user and the prior document in a map as a distribution chart. In the map, the center of the map is determined as the invention of the user, and as a degree of similarity of the prior document becomes high, the prior document is plotted in a position close to the center. The user may recognize similarity between the invention of the user and the plurality of prior documents. Furthermore, the user may detect an appropriate existing patent, a paper and the like as a prior document of the invention of the user. Furthermore, the user may determine the patentability of the invention of the user by checking the prior documents similar to the invention of the user. For example, when a large number of plots are located in positions near the center (the invention of the user) in the map, the user may recognize a large number of prior documents that are similar to the invention of the user and add a new idea to enhance the patentability of the invention of the user. Furthermore, when only a small number of plots are located in positions near the center in the map, the user may recognize a small number of prior documents similar to the invention of the user and discuss a plurality of applications or increase of a range of the invention of this application.

Furthermore, in a plurality of inventions of the user, the IP liaison function may determine the plurality of inventions of the user as a cluster and display a map of the plurality of visualized prior document groups which are close to the cluster (a cluster of the prior documents).

Furthermore, the IP liaison function may specify a researcher or the like who performs research and development similar to those of the inventor in accordance with information on the inventor who participates in the chat room 1003. The intellectual property supporting apparatus 1 connects to a service providing information associated with a plurality of inventors to specify a researcher who performs the research and development similar to those performed by the inventor who participates in the chat room 1003. The intellectual property supporting apparatus 1 may automatically upload the information regarding the specified researcher in the chat room 1003.

The liaison screen 1000 may include a group icon 1001 corresponding to a group including a plurality of users and a foreign agent. The user may transmit or receive text information and information on a procedure in the chat room 1003 by communication with the plurality of users and the foreign agent included in the group. The user may determine a group that transmits and receives various information using the chat room 1003 by selecting the group icon 1001 included in the liaison screen 1000. The liaison screen 1000 may include the group icon 1001 corresponding to a plurality of groups. The group icon 1001 that may not be displayed in the liaison screen 1000 may be displayed by scroll of a region in which the group icon 101 is displayed in the liaison screen 1000 performed by the user.

When the user selects the group icon 1001 corresponding to a group in the liaison screen 1000, the chat room 1003 used to transmit and receive information between users and a foreign attorney who belong to the group corresponding to the selected group icon 1001 is displayed in a region for displaying the chat room 1003 in the liaison screen 1000. Therefore, the user may transmit and receive certain information in communication with the other users and the foreign attorney who belong to the group corresponding to the selected group icon 1001 using the displayed chat room 1003.

The liaison screen 1000 may include the member icon 1002 corresponding to other users associated with the user. The user selects the member icon 1002 corresponding to another user in the liaison screen 1000 so that the selected other user may participate in the chat room 1003. For example, the user selects the member icon 1002 corresponding to a user A included in the other users so that the user A may participate in the chat room 1003. The other users who participate in the chat room 1003 may register (upload) text information and information on a procedure in the chat room 1003. The liaison screen 1000 may include the member icons 1002 corresponding to the other users. The member icons 1002 not displayed in the liaison screen 1000 may be displayed when the user scrolls the region including the member icons 1002 in the liaison screen 1000.

When the user selects the member icons 1002 corresponding to the other users in the liaison screen 1000, the chat room 1003 used to transmit and receive certain information in communication with the other users corresponding to the member icons 1002 is displayed in a region for displaying the chat room 1003. Therefore, the user may transmit and receive certain information in communication with another user corresponding to the selected member icon 1002 using the displayed chat room 1003.

The liaison screen 1000 may include attorney icons 1004 corresponding to a plurality of foreign attorneys. The user may select the attorney icon 1004 so that a foreign attorney requested to perform a procedure participates in the chat room 1003 and may perform exchange of information with the foreign attorney. Furthermore, the liaison screen 1000 may include attorney icons 1004 corresponding to a plurality of foreign attorneys. The attorney icons 1004 not displayed in the liaison screen 1000 may be displayed by scrolling a region in which the attorney icon 1004 is displayed in the liaison screen 1000 performed by the user.

Information on the attorney may be displayed in the attorney icon 1004. A name of the attorney or a name of a patent office or a law firm to which the attorney belongs may be displayed in the attorney icon 1004, for example. Furthermore, a cost and a period of time required for a procedure when the attorney is requested to perform the procedure may be displayed for each attorney. The user may check the cost and the period of time before selecting the attorney who is asked to perform the procedure.

When the user clicks the attorney icon 1004 to check detailed information of a plurality of attorneys, a page for checking the detailed information may be displayed. As the detailed information, detailed content of a patent office or a law firm to which the attorney belongs, a cost required for the procedure, a carrier of the attorney, and the like may be displayed. The user may determine an attorney who performs the procedure by checking the cost required to perform the procedure for each attorney. On the other hand, the attorney may display a cost after discount, for example, to be selected by the user.

The liaison screen 1000 may include the calendar icon 105 corresponding to a calendar function. A calendar function provided in a low cost or free may be used, for example. When the calendar icon 1005 corresponding to the calendar function is selected, the calendar screen (not illustrated) displaying a calendar may be displayed and the calendar may be displayed in the liaison screen 1000.

The liaison screen 1000 may include the folder icon 1006 corresponding to a folder function. The folder function stores information on the procedure of upload by the user to the chat room 1003. When the folder icon 1006 corresponding to the folder function is selected, a folder screen (not illustrated) displaying a folder may be displayed or the folder may be displayed in the liaison screen 1000.

The liaison screen 1000 may include a TV conference icon 1008 corresponding to a function of holding a TV conference with a foreign attorney. When the user specifies the attorney icon 1004 corresponding to a foreign attorney who performs a TV conference and selects the TV conference icon 1008 corresponding to the TV conference, a TV conference screen (not illustrated) for the TV conference performed with the specified foreign attorney may be displayed, and the TV conference screen may be displayed in the liaison screen 1000.

By performing the TV conference with the foreign attorney, the foreign attorney may directly explain content of the procedure and a cost required for the procedure for the user.

The liaison screen 1000 may include the translation icon 1007 corresponding to a translation function, and the translation icon 1007 corresponding to translation may be displayed as “Translation.”

The translation function translates certain information uploaded by the user or the foreign attorney. When the user uploads a file described in Japanese to the chat room 1003, for example, the translation function translates the file into English or Chinese. Furthermore, the translation function translates the file uploaded by the foreign attorney and described in English or Chinese into Japanese.

It is preferable that the translation function appropriately translates expression and content unique to the intellectual property. The translation function may be hybrid type machine translation which is a combination of rule-type machine translation in which translation is performed based on a rule which defines certain expressions and content in advance and statistical-type machine translation in which translation is performed by statistically learning translation models based on a large number of translation sentences (example sentences and past translation results). The rule-type machine translation performs translation using combinations of keywords and grammar, for example, and therefore, mistranslation is reduced even in a field of the intellectual property including unique expressions. Furthermore, the statistical-type machine translation performs translation using a mechanically-learnt translation model and, therefore, the translation may be performed so that content having a reduced number of mistranslation. The translation function of the intellectual property supporting apparatus 1 performs hybrid translation of these and, therefore, even the intellectual property including various technical fields and a law field may be translated with a reduced number of mistranslation.

The translation function may be performed by a translator or automatic translation may be employed.

When the user specifies a file uploaded in the chat room 1003 on the chat room 1003 and selects the translation icon 1007, the specified file is translated in a predetermined language. When the translation icon 1007 is selected, a tab or an icon used to further select a translation language may be displayed. The user may translate the specified file into the selected language by selecting the tab or the icon of the translation language.

In the intellectual property supporting apparatus 1 according to the example, a file may be translated using a low-cost translation service, a free translation service or the like.

Furthermore, according to the example, the translation function may be automatically executed on a file when the file is uploaded to the chat room 1003 by the user or the foreign attorney.

The liaison screen 1000 may display an icon corresponding to “IP liaison” as an IP liaison icon 1009, and the chat room 1003 may be displayed when the IP liaison icon 1009 is selected.

The liaison screen 1000 may include a procedure flow icon 1010 corresponding to a “procedure flow.”

1. An intellectual property supporting apparatus comprising a computer configured to:
record prior art information and character information in a recording unit;
output a character to a user terminal operable by a user based on the character information recorded in the recording unit;
receive information regarding intellectual property associated with the user as an inventor or an applicant transmitted from the user terminal;
calculate right acquisition possibility of the intellectual property based on the prior art information and the information regarding the intellectual property, generate in advance learning data used for machine learning to calculate the right acquisition possibility using the prior art information recorded in the recording unit, use the machine learning to (1) calculate the information on the right acquisition possibility from the learning data and the information regarding the intellectual property, and 2) extract a new keyword to be added to the information regarding the intellectual property from the prior art information based on the learning data and the information on the right acquisition possibility, the keyword corresponding to a distance movement in which a distance in a projection in the machine learning is not rejected; and
control output of a form of the character based on information on the calculated right acquisition possibility and output the new keyword through the character.

2-3. (canceled)

4. The intellectual property supporting apparatus according to claim 1, further comprising:
an extraction unit configured to extract information corresponding to the information regarding the intellectual property from the prior art information,
wherein the calculation unit calculates the information on the right acquisition possibility based on the corresponding information.

5. The intellectual property supporting apparatus according to claim 4, wherein the extraction unit compares the information regarding the intellectual property to a cited reference of the corresponding information for each component to calculate a matching point and a different point between the information regarding the intellectual property and the cited reference and extracts a second cited reference based on the different point as a result of the comparison.

6. The intellectual property supporting apparatus according to claim 5, wherein the controller selects a form of the character based on the new similar information.

7. The intellectual property supporting apparatus according to claim 6, wherein the controller indicates the information on the right acquisition possibility through the character.

8. An intellectual property supporting method causing a computer to perform the steps of:
recording prior art information and character information in a recording unit;
outputting a character to a user terminal operable by a user based on the recorded character information;
receiving information regarding intellectual property transmitted from the user terminal;
calculating right acquisition possibility of the intellectual property based on the prior art information and the information regarding the intellectual property, generating in advance learning data used for machine learning to calculate the right acquisition possibility using the prior art information recorded in the recording unit, using the machine learning to (1) calculate the information on the right acquisition possibility from the learning data and the information regarding the intellectual property, and 2) extracting a new keyword to be added to the information regarding the intellectual property from the prior art information based on the learning data and the information on the right acquisition possibility, the keyword corresponding to a distance movement in which a distance in a projection in the machine learning is not rejected; and
controlling output of a form of the character based on calculated information on the right acquisition possibility and outputting the new keyword through the character.

9. An intellectual property supporting program recorded on a computer that causes the computer to execute:
a recording function of recording prior art information and character information;
an outputting function of outputting a character to a user terminal operable by a user based on the recorded character information;
a reception function of receiving information regarding intellectual property transmitted from the user terminal;
a calculation function of calculating right acquisition possibility of the intellectual property based on the intellectual property information and the information regarding the intellectual property, generating in advance learning data used for machine learning to calculate the right acquisition possibility using the prior art information recorded in the recording unit, using the machine learning to (1) calculate the information on the right acquisition possibility from the learning data and the information regarding the intellectual property, and 2) extract a new keyword to be added to the information regarding the intellectual property from the prior art information based on the learning data and the information on the right acquisition possibility, the keyword corresponding to a distance movement in which a distance in a projection in the machine learning is not rejected; and
a control function of controlling output of a form of the character based on calculated information on the right acquisition possibility and outputting the new keyword through the character.
